(19) United States
(12) Patent Application Publication
(10) Pub. No.: US 2024/0288756 A1
(43) Pub. Date: Aug. 29, 2024

(54) VIDEO PROJECTION DEVICE, VIDEO PROJECTION METHOD, AND PROGRAM

(71) Applicant: NIPPON TELEGRAPH AND TELEPHONE CORPORATION, Tokyo (JP)

(72) Inventor: Makoto MUTO, Tokyo (JP)

(73) Assignee: NIPPON TELEGRAPH AND TELEPHONE CORPORATION, Tokyo (JP)

(21) Appl. No.: 18/568,319

(22) PCT Filed: Jun. 10, 2021
(86) PCT No.: PCT/JP2021/022208

§ 371 Date: Dec. 8, 2023

(51) Int. Cl. G03B 21/14; G06T 7/70; H04N 5/74

(52) U.S. Cl. CPC G03B 21/147; G06T 7/70; H04N 5/74; G06T 2207/10016

(57) ABSTRACT

A video projection device (1) according to the present invention includes: a subject extraction unit (11) that extracts a plurality of subjects from an imaged video; a subject position grasping unit (12) that grasps a position of the subject; a subject projection destination determination unit (13) that determines a projection destination of the subject on the basis of the position of the subject; and a plurality of virtual image display units (14) that displays a virtual image of the subject according to determination by the subject projection destination determination unit (13).

### TECHNICAL FIELD

The present invention relates to a video projection device, a video projection method, and a program.

### BACKGROUND ART

In recent years, a technique for presenting a video as if a subject were present ahead has been proposed. For example, Non Patent Literature 1 describes a display system that presents a virtual image (2D floating image) with a simple configuration.

Furthermore, in order to present a subject (for example, a video obtained by cutting out a player portion in a video of a badminton competition) in a video to a viewer with a more realistic sense of depth, there is a method of disposing a plurality of pseudo virtual image devices from the near side to the far side as viewed from the viewer, and displaying the subject in a form that matches the actual depth. By the present method, the subject actually located on the near side is displayed on the pseudo virtual image device disposed on the near side, and the subject actually located on the far side is displayed on the pseudo virtual image device disposed on the far side, and therefore, the viewer can obtain a more realistic sense of depth. Here, by using a transparent virtual image device, a portion that is not the subject can be seen through, so that the subject on the far side projected on the virtual image device on the far side relative to the portion that is seen through can be seen.

That is, as illustrated in FIG. 13A, by setting a position (P1) of a far-side virtual image device 16a and a position (P2) of a near-side virtual image device 16b at a certain interval (P1>>P2) according to a distance (T1) to a far-side subject 20 and a distance (T2) to a near-side subject 21 as viewed from a video imaging device 2, the position (P1) to a far-side virtual image 20′ and the position (P2) to a near-side virtual image 21′ seen from a viewer S roughly coincide respectively with the distances (T1 and T2) to the real subjects 20 and 21, so that the viewer can obtain a more realistic sense of depth. As illustrated in FIG. 13B, a near-side virtual image device 16b and a far-side virtual image device 16a are disposed at a certain interval (P1>>P2) in a depth direction (Z-axis direction).

### CITATION LIST

### Non Patent Literature

Non Patent Literature 1: “Promotion of Research and Development of ‘Kirari! for Arena’ Highly Realistic Public Viewing from Multiple Directions”, [online], Feb. 18, 2015, [searched on May 25, 2021], the Internet <URL: https://journal.ntt.co.jp/wp-content/uploads/2020/06/JN20181021.pdf>

### SUMMARY OF INVENTION

### Technical Problem

However, the conventional technique does not assume that the far-side subject 20 and the near-side subject 21 move in a wide range. For example, as illustrated in FIG. 14A, in a case where the far-side subject 20 moves to a position close to the near-side subject 21, a distance (T1′) to the real subject 20 has a value close to a distance (T2) to the near-side subject 21. On the other hand, the position (P1) to the virtual image 20′ viewed from the viewer S remains at P1 regardless of the change. As a result, since the distance to the real subject 20 and the distance to the virtual image device 16a do not coincide, the viewer S cannot obtain a realistic sense of depth. As illustrated in FIG. 14B, the near-side virtual image device 16b and the far-side virtual image device 16a are disposed at a certain interval (P1>>P2) in the depth direction (Z-axis direction), but the movement of the far-side subject 20 to the position close to the near-side subject 21 is not reflected.

As described above, the conventional technique has a problem that a viewer of a virtual image device cannot obtain a realistic sense of depth when a subject moves in a wide range.

An object of the present disclosure made in view of such circumstances is to enable displaying a virtual image of a subject without impairing a realistic sense of depth even when the subject moves in a wide range.

### Solution to Problem

In order to solve the above problem, a video projection device according to a first embodiment is a video projection device that projects a video of a subject onto a plurality of virtual image devices, the video projection device including: a subject extraction unit that extracts a plurality of subjects from an imaged video; a subject position grasping unit that grasps a position of the subject; a subject projection destination determination unit that determines a projection destination of the subject on the basis of the position of the subject; and a plurality of virtual image display units that displays a virtual image of the subject according to determination by the subject projection destination determination unit.

In order to solve the above problem, a video projection method according to the first embodiment is a video projection method that projects a video of a subject onto a plurality of virtual image devices, the video projection method including, with a video projection device: a step of extracting a plurality of subjects from an imaged video; a step of grasping a position of the subject; a step of determining a projection destination of the subject on the basis of the position of the subject; and a step of displaying a virtual image of the subject according to determination of the projection destination of the subject.

In order to solve the above problem, a program according to the first embodiment causes a computer to function as the above video projection device.

### Advantageous Effects of Invention

According to the present disclosure, it is possible to display a subject without impairing a realistic sense of depth even when the subject moves in a wide range.

### BRIEF DESCRIPTION OF DRAWINGS

FIG. 1 is a block diagram illustrating a configuration example of a video projection device according to the first embodiment.

FIG. 2 is a flowchart illustrating an example of a video projection method executed by the video projection device according to the first embodiment.

FIG. 3 is a block diagram illustrating a configuration example of a video projection device according to a second embodiment.

FIG. 4A is a schematic diagram describing a subject projection destination determination technique according to the second embodiment.

FIG. 4B is a schematic diagram describing the subject projection destination determination technique according to the second embodiment.

FIG. 4C is a schematic diagram describing the subject projection destination determination technique according to the second embodiment.

FIG. 5 is a flowchart illustrating an example of a video projection method executed by the video projection device according to the second embodiment.

FIG. 6 is a block diagram illustrating a configuration example of a video projection device according to a third embodiment.

FIG. 7 is a schematic diagram describing a subject projection destination determination technique according to the third embodiment.

FIG. 8 is a flowchart illustrating an example of a video projection method executed by the video projection device according to the third embodiment.

FIG. 9 is a block diagram illustrating a configuration example of a video projection device according to a fourth embodiment.

FIG. 10 is a schematic diagram describing a subject projection destination determination technique according to the fourth embodiment.

FIG. 11 is a flowchart illustrating an example of a video projection method executed by the video projection device according to the fourth embodiment.

FIG. 12 is a block diagram illustrating a schematic configuration of a computer that functions as the video projection device.

FIG. 13A is a schematic diagram describing a conventional subject video projection technique.

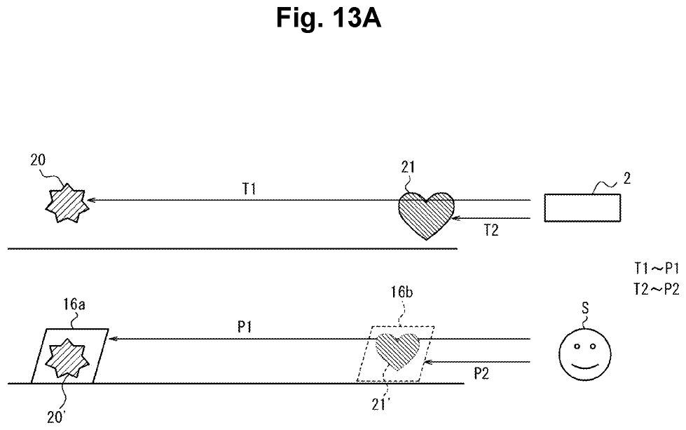

FIG. 13B is a schematic diagram describing a conventional subject video projection technique.

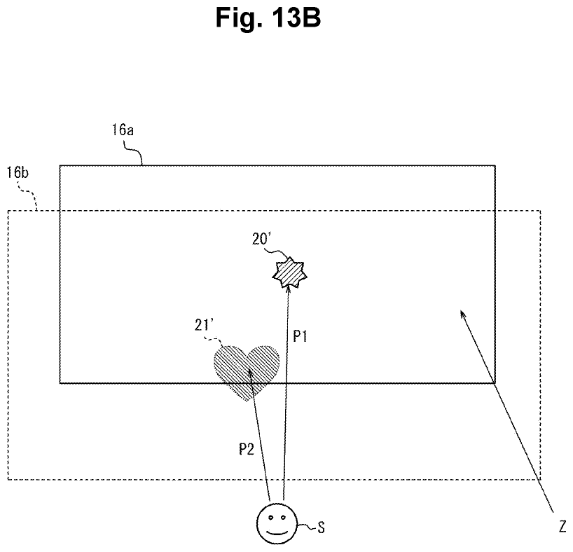

FIG. 14A is a schematic diagram describing a problem of the conventional technique to be solved by the present invention.

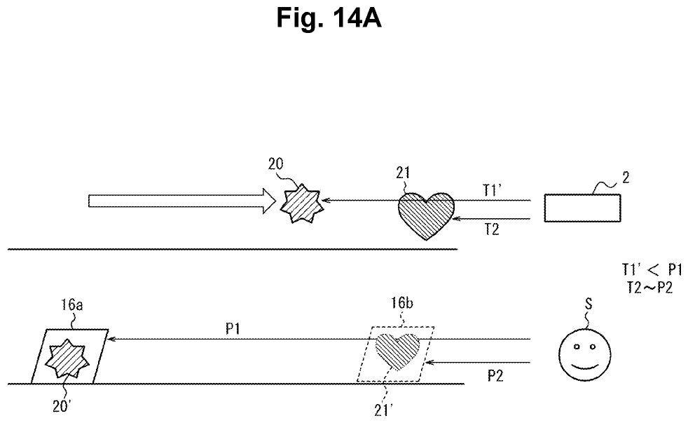

FIG. 14B is a schematic diagram describing a problem of the conventional technique to be solved by the present invention.

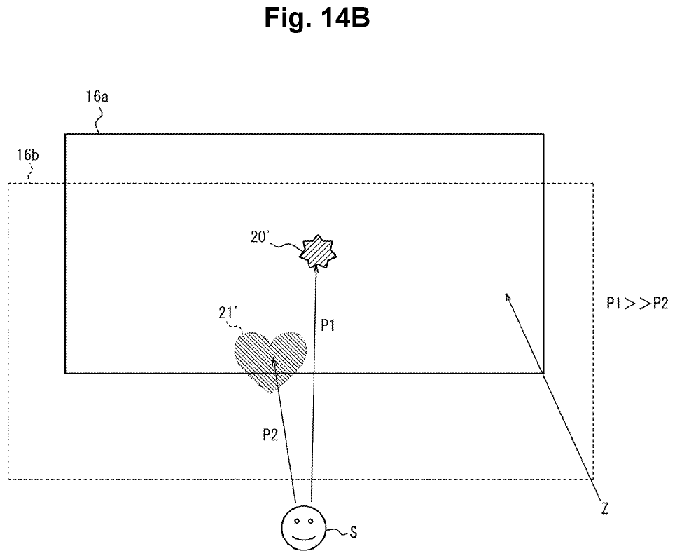

### DESCRIPTION OF EMBODIMENTS

Hereinafter, modes for carrying out the present invention will be described in detail with reference to the drawings.

### First Embodiment

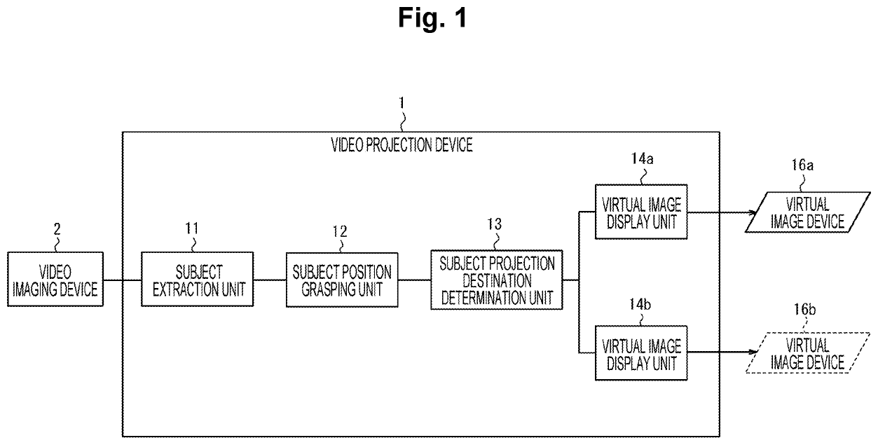

FIG. 1 is a block diagram illustrating a configuration example of a video projection device 1 according to the first embodiment. The video projection device 1 illustrated in FIG. 1 includes a subject extraction unit 11, a subject position grasping unit 12, a subject projection destination determination unit 13, and a plurality of virtual image display units 14 (in the present disclosure, a virtual image display unit 14a and a virtual image display unit 14b are described separately). The video projection device 1 projects a video of a subject onto a plurality of virtual image devices (in the present disclosure, a virtual image device 16a and a virtual image device 16b are described separately).

The subject extraction unit 11 extracts a plurality of subjects from the imaged video imaged by the video imaging device 2. The subject extraction unit 11 extracts a subject using an image processing technique, a deep learning technique, or the like. The video imaging device 2 may be a camera that images a subject or may be a reproduction device. The subject extraction unit 11 outputs the video of the extracted plurality of subjects to the subject position grasping unit 12.

The subject position grasping unit 12 grasps the position of the subject extracted by the subject extraction unit 11. The subject position grasping unit 12 grasps the position of the subject using an image processing technique or the like, and outputs the video of the subject and the grasped position information to the subject projection destination determination unit 13.

The subject projection destination determination unit 13 determines the projection destination of the subject on the basis of the position of the subject grasped by the subject position grasping unit 12. The subject projection destination determination unit 13 outputs the video of the subject extracted by the subject extraction unit 11 to the virtual image display unit 14, which is determined as the projection destination of the subject and will be described below.

The plurality of virtual image display units 14 (in the present disclosure, the virtual image display unit 14a and the virtual image display unit 14b are described separately) displays the virtual image of the subject according to the determination of the subject projection destination determination unit 13. The virtual image display unit 14a causes the far-side virtual image device 16a to display the virtual image of the subject extracted by the subject extraction unit 11. On the other hand, the virtual image display unit 14b causes the near-side virtual image device 16b to display the virtual image of the subject. A holographic technique or the like is used to display the virtual image. The virtual image device 16a and the virtual image device 16b include, for example, a display and a half mirror as illustrated in Non Patent Literature 1. The virtual image may be displayed on the display constituting the virtual image device 16a and the virtual image device 16b, or may be displayed in a space corresponding to the virtual image device 16a and the virtual image device 16b.

Thus, the video projection device 1 switches the display position on the virtual image device according to the position of the subject.

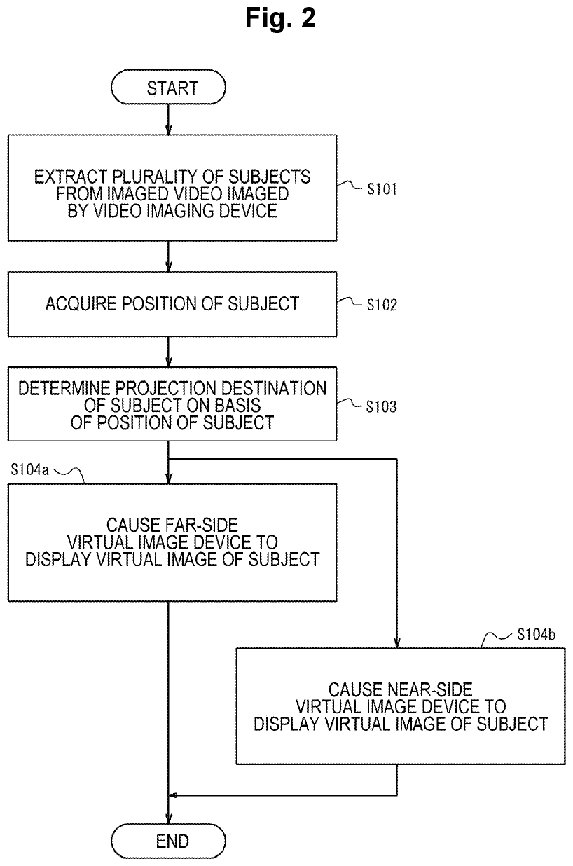

FIG. 2 is a flowchart illustrating an example of a video projection method executed by the video projection device 1.

In step S101, the subject extraction unit 11 extracts a plurality of subjects from the imaged video imaged by the video imaging device 2.

In step S102, the subject position grasping unit 12 acquires the position of the subject extracted by the subject extraction unit 11.

In step S103, the subject projection destination determination unit 13 determines the projection destination of the subject on the basis of the position of the subject.

In step S104a, the virtual image display unit 14a causes the far-side virtual image device 16a to display the virtual image of the subject extracted by the subject extraction unit 11.

In step S104b, the virtual image display unit 14b causes the near-side virtual image device 16b to display the virtual image of the subject extracted by the subject extraction unit 11.

With the video projection device 1 according to the present embodiment, it is possible to display a subject without impairing a realistic sense of depth even when the subject moves in a wide range.

### Second Embodiment

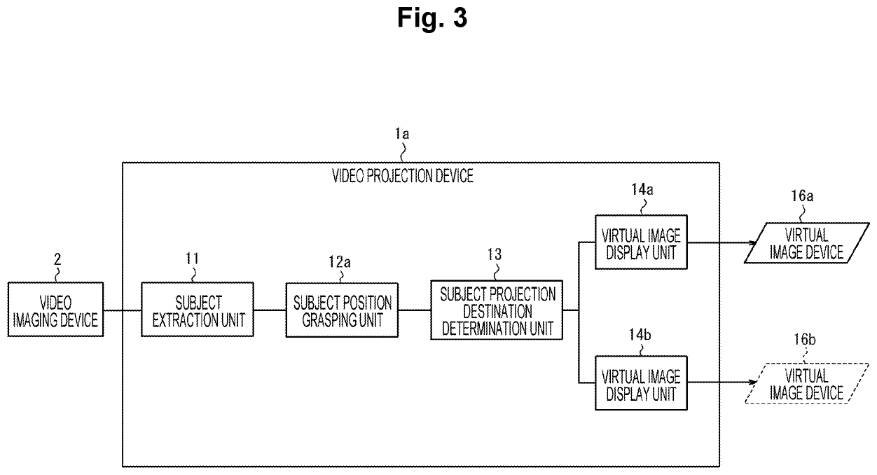

FIG. 3 is a block diagram illustrating a configuration example of a video projection device 1a according to the second embodiment. The video projection device 1a illustrated in FIG. 3 includes the subject extraction unit 11, a subject position grasping unit 12a, the subject projection destination determination unit 13, the virtual image display unit 14a, and the virtual image display unit 14b. The video projection device 1a is different from the video projection device 1 according to the first embodiment in that the subject position grasping unit 12a is provided instead of the subject position grasping unit 12. The same configurations as those of the first embodiment are denoted by the same reference numerals as those of the first embodiment, and the description thereof will be omitted as appropriate.

The subject position grasping unit 12a estimates the depth of the subject extracted by the subject extraction unit 11. The depth of the subject is estimated using an image processing technique, a deep learning technique, or a depth sensor. The subject position grasping unit 12a outputs the video of the subject and the estimated depth of the subject to the subject projection destination determination unit 13.

The subject projection destination determination unit 13 determines the projection destination of the subject on the basis of whether the depth of the subject exceeds a threshold value. The subject projection destination determination unit 13 outputs the video of the subject extracted by the subject extraction unit 11 to one of the virtual image display unit 14a and the virtual image display unit 14b depending on the determination of the projection destination of the subject.

In the present embodiment, the depth of the real subject is estimated, and the projection destination of the subject is determined on the basis of whether it exceeds a certain threshold value.

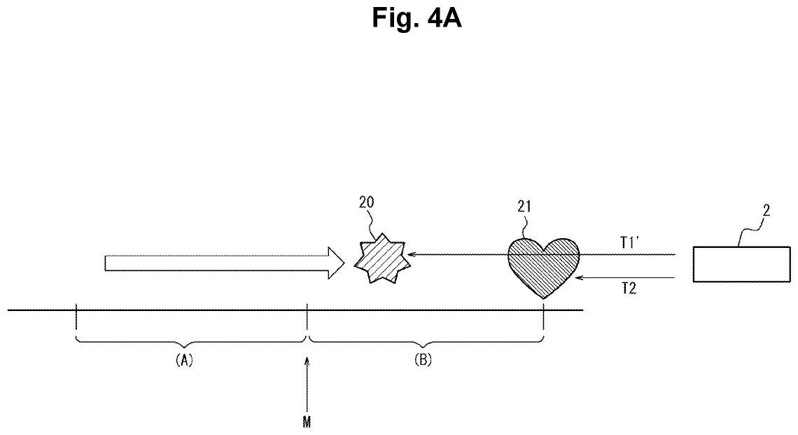

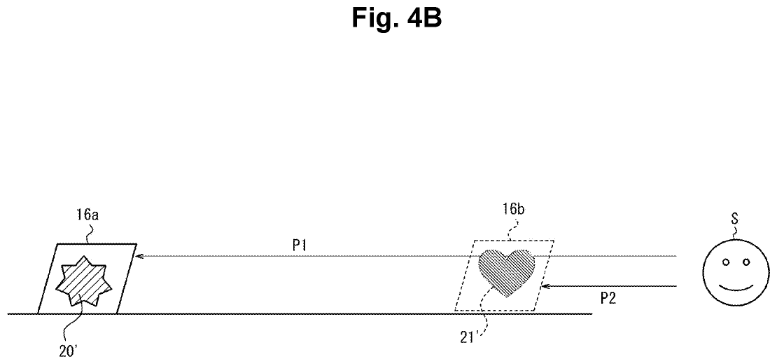

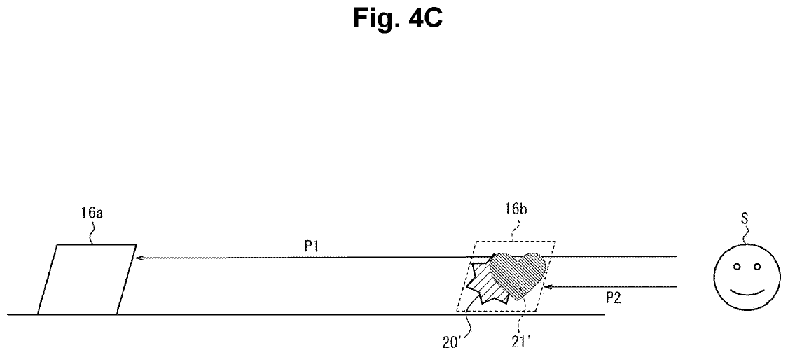

For example, as illustrated in FIG. 4A, in a case where the far-side subject 20 as viewed from the video imaging device 2 moves to a position close to the near-side subject 21, cases where the position of the real subject 20 is in the range of (A) and in the range of (B) relative to the threshold value are considered. In the drawing, the distance to the real subject 20 that has moved is denoted by T1′, and the distance to the near-side subject 21 that has not moved is denoted by T2.

As illustrated in FIG. 4B, when the position of the subject 20 is in the range of (A), the far-side virtual image 20′ is displayed by the far-side virtual image device 16a.

As illustrated in FIG. 4C, when the position of the subject 20 is in the range of (B), the far-side virtual image 20′ is displayed by the near-side virtual image device 16b.

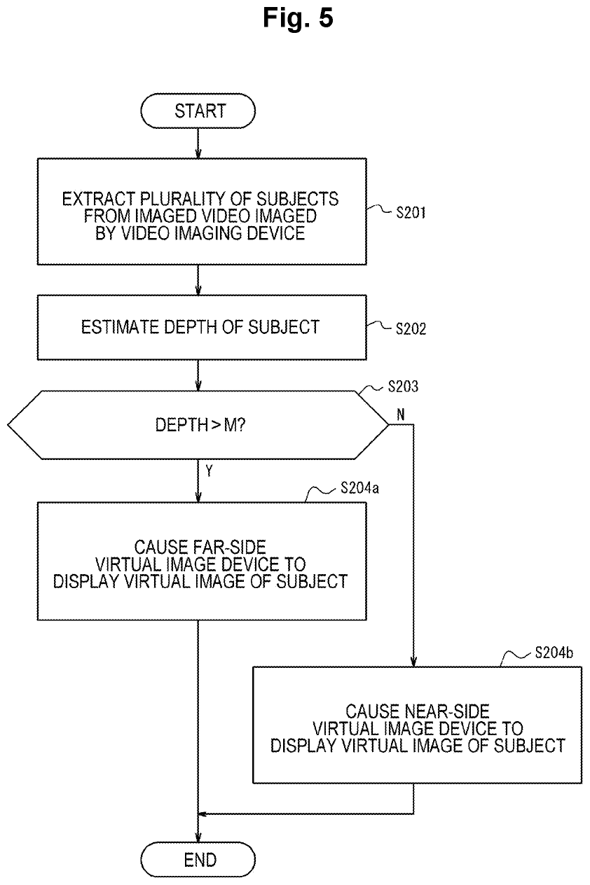

FIG. 5 is a flowchart illustrating an example of a video projection method executed by the video projection device 1a.

In step S201, the subject extraction unit 11 extracts a plurality of subjects from the imaged video imaged by the video imaging device 2.

In step S202, the subject position grasping unit 12a estimates the depth of the subject extracted by the subject extraction unit 11.

In step S203, the subject projection destination determination unit 13 determines the projection destination of the subject on the basis of whether the depth of the subject exceeds a threshold value M.

In step S204a, when the depth of the subject exceeds the threshold value M, the virtual image display unit 14a causes the far-side virtual image device 16a to display the virtual image of the subject extracted by the subject extraction unit 11.

In step S204b, when the depth of the subject does not exceed the threshold value M, the virtual image display unit 14b causes the near-side virtual image device 16b to display the virtual image of the subject extracted by the subject extraction unit 11.

With the video projection device 1a according to the present embodiment, it is possible to display a subject without impairing a realistic sense of depth even when the subject moves in a wide range in the depth direction (Z-axis direction).

### Third Embodiment

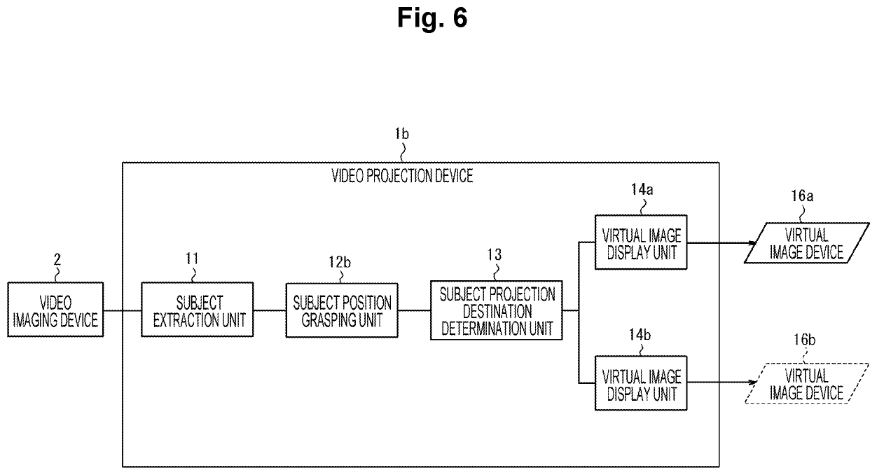

FIG. 6 is a block diagram illustrating a configuration example of a video projection device 1b according to the third embodiment. The video projection device 1b illustrated in FIG. 6 includes the subject extraction unit 11, a subject position grasping unit 12b, the subject projection destination determination unit 13, the virtual image display unit 14a, and the virtual image display unit 14b. The video projection device 1b is different from the video projection device 1 according to the first embodiment in that the subject position grasping unit 12b is provided instead of the subject position grasping unit 12. The same configurations as those of the first embodiment are denoted by the same reference numerals as those of the first embodiment, and the description thereof will be omitted as appropriate.

The subject extraction unit 11 acquires coordinates in a vertical direction in which the subject is located (hereinafter, referred to as Y coordinate, which may be simply referred to as Y), and outputs the video of the subject and the Y coordinate to the subject position grasping unit 12b.

The subject position grasping unit 12b determines the vertex position of the subject on the basis of the fact that the subject falls a predetermined distance from the vertex position in a case where the subject is an object (for example, a shuttle of badminton) that moves back and forth in the depth direction (Z coordinate direction) to draw the trajectory of an arc. The subject position grasping unit 12b outputs the video of the subject and the determination result to the subject projection destination determination unit 13.

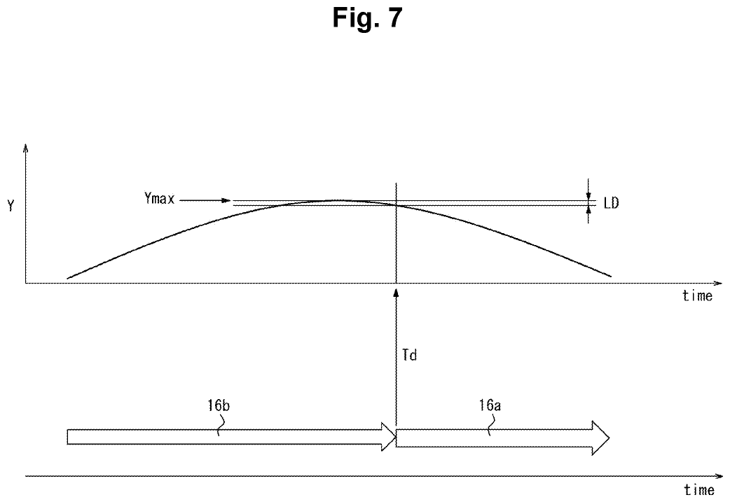

Here, a method in which the subject position grasping unit 12b determines whether the subject has reached the vertex will be described with reference to FIG. 7. As illustrated in FIG. 7, the subject position grasping unit 12b determines that the Y coordinate of the position of the subject changes from the rising direction to the falling direction and then the subject falls a “vertex determination fall distance Ld” from a “maximum value Ymax of the Y coordinate” and has reached the vertex. When the object moves in a real space, an ideal arc is not necessarily drawn. For example, when the object is a shuttle, the shuttle always moves with fine up-down movement. In this regard, the subject position grasping unit 12b can unfailingly determine that the object has reached the vertex by setting and determining the “vertex determination fall distance Ld” to a size exceeding the up-down movement.

When the subject position grasping unit 12b determines that the subject has reached the vertex, the subject projection destination determination unit 13 switches the projection destination of the subject. The subject projection destination determination unit 13 outputs the video of the subject extracted by the subject extraction unit 11 to one of the virtual image display unit 14a and the virtual image display unit 14b depending on the determination of the projection destination of the subject.

In the second embodiment, the subject position grasping unit 12a estimates the depth of the subject using an image processing technique, a deep learning technique, or a depth sensor. However, in a case where the subject is small object such as a shuttle of badminton, it is difficult to accurately estimate the depth from each frame image.

In the present embodiment, it is assumed that the subject is an object that moves back and forth between the near side and the far side to draw the trajectory of an arc such as a shuttle. As illustrated in FIG. 7, the subject projection destination determination unit 13 switches the projection destination relative to a time point Td at which it is determined that the subject has reached the vertex on the trajectory of the arc on which the subject moves. Specifically, as illustrated in FIG. 7, in a case where the shuttle moves from the near side to the far side, the subject projection destination determination unit 13 determines that the near-side virtual image device 16b is the projection destination before reaching the vertex and the far-side virtual image device 16a is the projection destination after reaching the vertex relative to the time point Td at which it is determined that the shuttle has reached the vertex. Similarly, in a case where the shuttle moves from the far side to the near side, the subject projection destination determination unit 13 determines that the far-side virtual image device 16a is the projection destination before reaching the vertex and the near-side virtual image device 16b is the projection destination after reaching the vertex relative to the vertex.

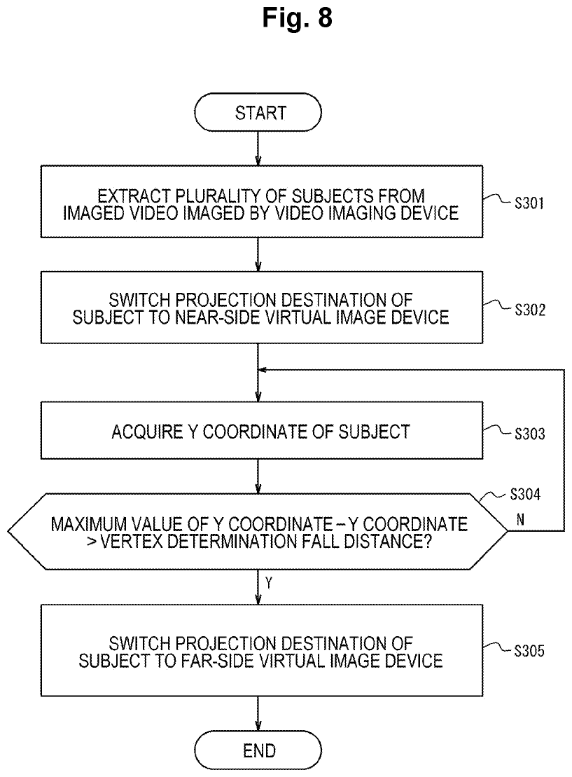

FIG. 8 is a flowchart illustrating an example of a video projection method executed by the video projection device 1b.

In step S301, the subject extraction unit 11 extracts a plurality of subjects from the imaged video imaged by the video imaging device 2.

In step S302, the subject projection destination determination unit 13 switches the projection destination of the subject to the near-side virtual image device 16b.

In step S303, the subject extraction unit 11 acquires the Y coordinate (Y) of the subject.

In step S304, the subject position grasping unit 12b determines whether the Formula (1) below is satisfied. In Formula (1), in a case where Formula (1) is satisfied, the processing proceeds to step S305. In a case where Formula (1) is not satisfied, the processing returns to step S303.

$$\begin{matrix}[ Math . 1 ] & \\ Maximum value ( Ymax ) of Y coordinate - Y coordinate ( Y ) > Vertex determination fall distance ( Ld ) & ( 1 )\end{matrix}$$

In step S305, the subject projection destination determination unit 13 switches the projection destination of the subject to the far-side virtual image device 16a.

With the video projection device 1b according to the present embodiment, it is possible to display the subject without impairing a realistic sense of depth even when the subject repeatedly rises and falls in the vertical direction (Y-coordinate direction) and moves in a wide range.

### Fourth Embodiment

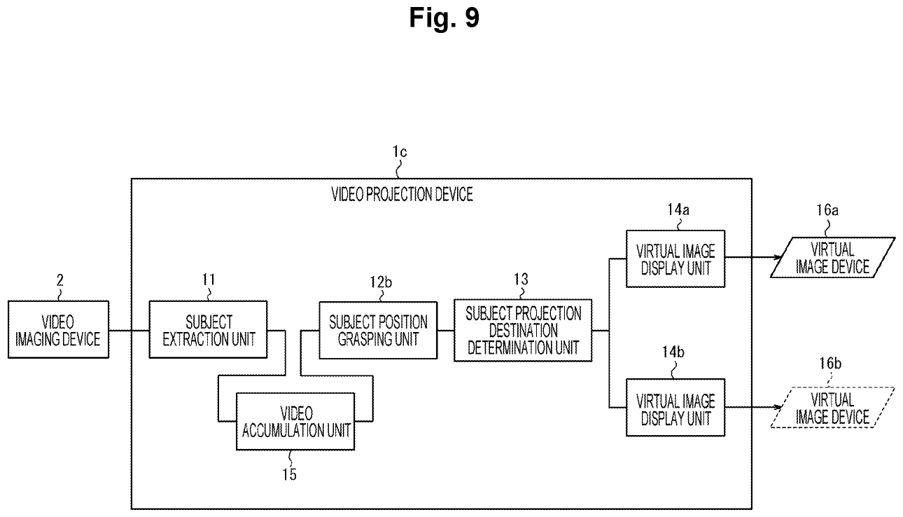

FIG. 9 is a block diagram illustrating a configuration example of a video projection device 1c according to the fourth embodiment. The video projection device 1c illustrated in FIG. 9 includes the subject extraction unit 11, the subject position grasping unit 12b, the subject projection destination determination unit 13, the virtual image display unit 14a, the virtual image display unit 14b, and a video accumulation unit (storage unit) 15. The video projection device 1c is different from the video projection device 1b according to the third embodiment in that the video accumulation unit 15 is further provided. The same configurations as those of the third embodiment are denoted by the same reference numerals as those of the third embodiment, and the description thereof will be omitted as appropriate.

The subject extraction unit 11 acquires the Y coordinate of the subject and outputs the video of the subject and the Y coordinate to the video accumulation unit 15.

The video accumulation unit 15 stores the video of the subject corresponding to a required determination time (hereinafter, referred to as the required determination time) required for the subject projection destination determination unit 13 to determine that the subject has reached the vertex, and delays the video. After the lapse of the required determination time, the video accumulation unit 15 starts sending an earlier video to the subject position grasping unit 12b. The video accumulation unit 15 may be a frame synchronizer used for delaying a video at a television station or the like.

The subject position grasping unit 12b determines the vertex position of the subject input from the video accumulation unit 15 on the basis of the subject falling a predetermined distance from the vertex position in a case where the subject is an object that moves back and forth to draw the trajectory of an arc. The subject position grasping unit 12b outputs the video of the subject and the determination result to the subject projection destination determination unit 13.

In the present embodiment, as in the third embodiment, it is assumed that the subject is an object that moves back and forth between the near side and the far side to draw the trajectory of an arc such as a shuttle. In the third embodiment, the subject projection destination determination unit 13 determines whether it is on the near side or on the far side relative to the time point at which it falls the “vertex determination fall distance” from the maximum value of the Y coordinate. However, since the projection destination of the subject is switched relative to the time point at which it falls the “vertex determination fall distance”, the projection destination cannot be switched at the time point at which it reaches the actual vertex.

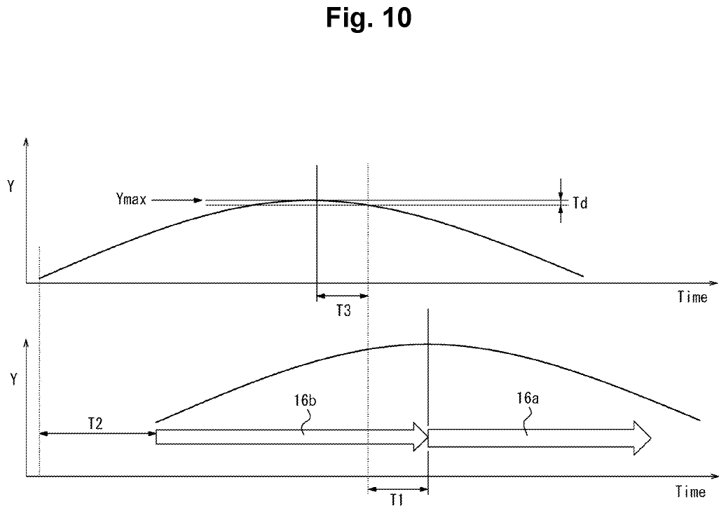

In the present embodiment, as illustrated in FIG. 10, the video projection device 1c delays the projection by required determination time T2. The required determination time T2 is a time required to determine that the subject has reached the vertex (for example, the maximum time required for the determination). Next, the video projection device 1c measures the time (vertex determination fall time T3) in which the Y coordinate is decreased by the vertex determination fall distance Ld from the time point at which the subject has reached the vertex (the Y coordinate becomes maximum). Then, the video projection device 1c calculates Formula (2) below, and switches the projection destination of the subject at a time point when switching adjustment time (T1) elapses.

$$\begin{matrix}[ Math . 2 ] & \\ Switching adjustment time ( T 1 ) = Required determination time ( T 2 ) - Vertex determination fall time ( T 3 ) & ( 2 )\end{matrix}$$

As a result, the video projection device 1c can switch the projection destination of the subject at a time point when the subject has actually reached the vertex.

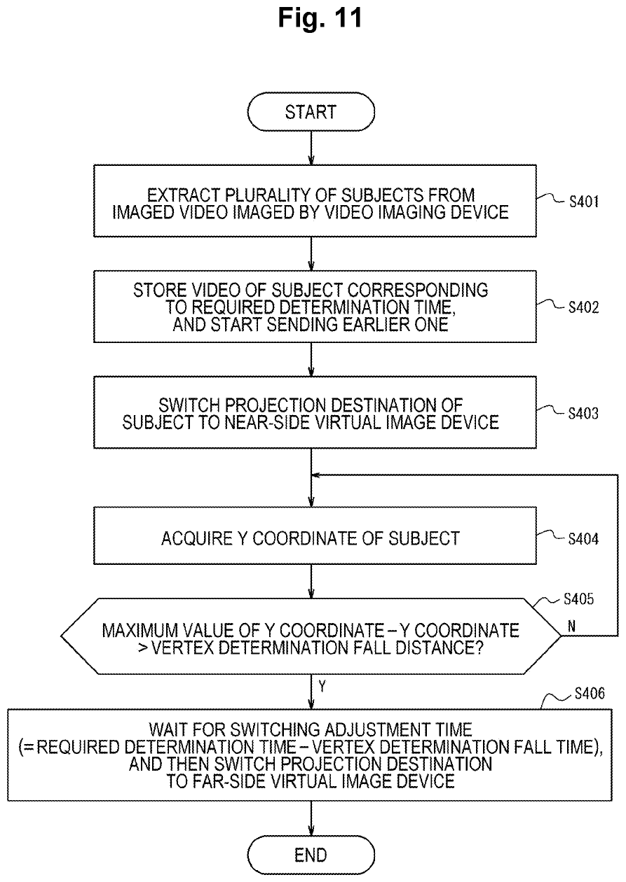

FIG. 11 is a flowchart illustrating an example of a video projection method executed by the video projection device 1c.

In step S401, the subject extraction unit 11 extracts a plurality of subjects from the imaged video imaged by the video imaging device 2.

In step S402, the video accumulation unit 15 stores the video of the subject corresponding to the required determination time, and starts sending an earlier video after the lapse of the required determination time.

In step S403, the subject projection destination determination unit 13 switches the projection destination of the subject to the near-side virtual image device 16b.

In step S404, the subject extraction unit 11 acquires the Y coordinate (Y) of the subject.

In step S405, the subject position grasping unit 12b determines whether the Formula (1) above is satisfied. In a case where Formula (1) is satisfied, the processing proceeds to step S406. In a case where Formula (1) is not satisfied, the processing returns to step S404.

In step S406, after waiting for the switching adjustment time T1 (=required determination time T2−vertex determination fall time T3), the subject projection destination determination unit 13 switches the projection destination to the far-side virtual image device 16a.

With the video projection device 1c according to the present embodiment, it is possible to display the subject without impairing a realistic sense of depth even when the subject repeatedly rises and falls in the vertical direction (Y-coordinate direction) and moves in a wide range since it is possible to switch the projection destination of the subject at a time point when the subject has actually reached the vertex.

The subject extraction unit 11, the subject position grasping unit 12, the subject position grasping unit 12a, the subject position grasping unit 12b, the subject projection destination determination unit 13, the virtual image display unit 14a, and the virtual image display unit 14b of the video projection devices 1, 1a, 1b, and 1c described above constitute a part of a control device (controller). The control device may be configured by dedicated hardware such as an application specific integrated circuit (ASIC) or a field-programmable gate array (FPGA), may be configured by a processor, or may be configured to include both dedicated hardware and a processor.

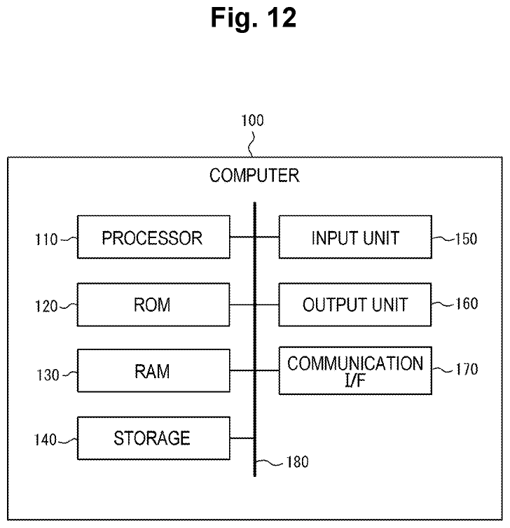

Furthermore, in order to function the video projection devices 1, 1a, 1b, and 1c described above, it is also possible to use a computer capable of executing a program instruction. FIG. 12 is a block diagram illustrating a schematic configuration of a computer that functions as the video projection devices 1, 1a, 1b, and 1c. Here, a computer 100 may be a general-purpose computer, a dedicated computer, a workstation, a personal computer (PC), an electronic note pad, or the like. The program instruction may be a program code, a code segment, or the like for executing required tasks.

As illustrated in FIG. 12, the computer 100 includes a processor 110, a read only memory (ROM) 120, a random access memory (RAM) 130, a storage 140 as storage units, an input unit 150, an output unit 160, and a communication interface (I/F) 170. The configurations are connected via a bus 180 so as to be capable of mutual communication. The subject extraction unit 11 of the video projection devices 1, 1a, 1b, and 1c described above may be constructed as the input unit 150, and the virtual image display unit 14a and the virtual image display unit 14b may be constructed as the output unit 160.

The ROM 120 stores various programs and various types of data. The RAM 130 temporarily stores a program or data as a working area. The storage 140 includes a hard disk drive (HDD) or a solid state drive (SSD) and stores various programs including an operating system and various types of data. In the present disclosure, a program according to the present disclosure is stored in the ROM 120 or the storage 140.

Specifically, the processor 110 is a central processing unit (CPU), a micro processing unit (MPU), a graphics processing unit (GPU), a digital signal processor (DSP), a system on a chip (SoC), or the like and may be configured by a plurality of processors of the same type or different types. The processor 110 reads a program from the ROM 120 or the storage 140 and executes the program by using the RAM 130 as a working area to perform control of each of the above-described configurations and various types of arithmetic processing. Note that at least a part of these processing contents may be realized by hardware.

The program may be recorded in a recording medium that can be read by the computer 100. When such a recording medium is used, the program can be installed in the computer 100. Here, the recording medium on which the program is recorded may be a non-transitory recording medium. The non-transitory recording medium is not particularly limited, but may be, for example, a CD-ROM, a DVD-ROM, a Universal Serial Bus (USB) memory, or the like. Furthermore, the program may be downloaded from an external device via a network.

With regard to the above embodiments, the following supplementary notes are further disclosed.

### (Supplementary Note 1)

A video projection device that projects a video of a subject onto a plurality of virtual image devices, the video projection device including:
a control unit that extracts a plurality of subjects from an imaged video, grasps a position of the subject, determines a projection destination of the subject on the basis of the position of the subject, and displays a virtual image of the subject according to determination of the projection destination of the subject.

### (Supplementary Note 2)

The video projection device according to Supplementary Note 1, in which the control unit estimates a depth of the subject, and determines the projection destination of the subject on the basis of whether the depth exceeds a threshold value.

### (Supplementary Note 3)

The video projection device according to Supplementary Note 1, in which the control unit determines a vertex position of the subject on the basis of the subject falling a predetermined distance from the vertex position in a case where the subject is an object that moves back and forth to draw a trajectory of an arc, and switches the projection destination of the subject when determining that the subject has reached a vertex.

### (Supplementary Note 4)

The video projection device according to Supplementary Note 3, further including:
a storage unit that stores a video of the subject corresponding to a required determination time required to determine that the subject has reached the vertex and delays the video, in which
the control unit determines the vertex position of the subject input from the storage unit.

### (Supplementary Note 5)

A video projection method that projects a video of a subject onto a plurality of virtual image devices, the video projection method including, with a video projection device:
a step of extracting a plurality of subjects from an imaged video; a step of grasping a position of the subject; a step of determining a projection destination of the subject on the basis of the position of the subject; and a step of displaying a virtual image of the subject according to determination of the projection destination of the subject.

### (Supplementary Note 6)

A non-transitory storage medium that stores a program capable of being executed by a computer, the non-transitory storage medium causing the computer to function as the video projection device according to any one of Supplementary Notes 1 to 4.

The above-described embodiments have been described as representative examples, and it is apparent to those skilled in the art that many modifications and substitutions can be made within the spirit and scope of the present disclosure. Therefore, it should not be understood that the present invention is limited by the above-described embodiments, and various modifications or changes can be made without departing from the scope of the claims. For example, a plurality of configuration blocks illustrated in the configuration diagrams of the embodiments can be combined into one, or one configuration block can be divided.

### REFERENCE SIGNS LIST

1, 1a, 1b, 1c Video projection device
2 Video imaging device
11 Subject extraction unit
12, 12a, 12b Subject position grasping unit
13 Subject projection destination determination unit
14 Virtual image display unit
14a Virtual image display unit (far side)
14b Virtual image display unit (near side)
15 Video accumulation unit (storage unit)
16a Virtual image device (far side)
16b Virtual image device (near side)
100 Computer
110 Processor
120 ROM
130 RAM
140 Storage
150 Input unit
160 Output unit
170 Communication interface (I/F)
180 Bus

1. A video projection device that projects a video of a subject onto a plurality of virtual image devices, the video projection device comprising a processor configured to execute operations comprising:
extracting a plurality of subjects from an imaged video;
identifying a position of the subject;
determining a projection destination of the subject on a basis of the position of the subject; and
displaying a virtual image of the subject according to the determined projection destination.

2. The video projection device according to claim 1, wherein
the extracting further comprises estimating a depth of the subject, and
the determining further comprises determining the projection destination of the subject on a basis of whether the depth exceeds a threshold value.

3. The video projection device according to claim 1, wherein
the identifying further comprises determining a vertex position of the subject on a basis of the subject falling a predetermined distance from the vertex position in a case where the subject is an object that moves back and forth to draw a trajectory of an arc, and
the determining further comprises switching the projection destination of the subject when the identified position of the subject indicates the subject has reached a vertex.

4. The video projection device according to claim 3, the processor further configured to execute operations comprising:
storing a video of the subject corresponding to a needed determination time needed for determining that the subject has reached the vertex and delays the video, wherein
the identifying further comprises determining the vertex position of the subject input from the stored video of the subject.

5. A video projection method for projecting a video of a subject onto a plurality of virtual image devices, the video projection method comprising:
extracting a plurality of subjects from an imaged video;
identifying a position of the subject;
determining a projection destination of the subject on a basis of the position of the subject; and
displaying a virtual image of the subject according to determination of the projection destination of the subject.

6. A computer-readable non-transitory recording medium storing a computer-executable program instructions that when executed by a processor cause a computer system to execute operations comprising:
extracting a plurality of subjects from an imaged video;
identifying a position of the subject;
determining a projection destination of the subject on a basis of the position of the subject; and
displaying a virtual image of the subject according to the determined projection destination.

7. The video projection device according to claim 1, wherein the subject includes a sport player playing a sport.

8. The video projection device according to claim 1, wherein the displaying further comprises displaying a trajectory of an arc according to the subject moves back and forth.

9. The video projection device according to claim 1, wherein the displaying the virtual image of the subject maintains a realistic sense of depth when the subject moves in a wide range in a depth direction of the imaged video.

10. The video projection method according to claim 5, wherein
the extracting further comprises estimating a depth of the subject, and
the determining further comprises determining the projection destination of the subject on a basis of whether the depth exceeds a threshold value.

11. The video projection method according to claim 5, wherein
the identifying further comprises determining a vertex position of the subject on a basis of the subject falling a predetermined distance from the vertex position in a case where the subject is an object that moves back and forth to draw a trajectory of an arc, and
the determining further comprises switching the projection destination of the subject when the identified position of the subject indicates the subject has reached a vertex.

12. The video projection method according to claim 5, further comprising:
storing a video of the subject corresponding to a needed determination time needed for determining that the subject has reached the vertex and delays the video, wherein
the identifying further comprises determining the vertex position of the subject input from the stored video of the subject.

13. The video projection method according to claim 5, wherein the subject includes a sport player playing a sport.

14. The video projection method according to claim 5, wherein the displaying further comprises displaying a trajectory of an arc according to the subject moves back and forth.

15. The video projection method according to claim 5, wherein the displaying the virtual image of the subject maintains a realistic sense of depth when the subject moves in a wide range in a depth direction of the imaged video.

16. The computer-readable non-transitory recording medium according to claim 6, wherein
the extracting further comprises estimating a depth of the subject, and
the determining further comprises determining the projection destination of the subject on a basis of whether the depth exceeds a threshold value.

17. The computer-readable non-transitory recording medium according to claim 6, wherein
the identifying further comprises determining a vertex position of the subject on a basis of the subject falling a predetermined distance from the vertex position in a case where the subject is an object that moves back and forth to draw a trajectory of an arc, and
the determining further comprises switching the projection destination of the subject when the identified position of the subject indicates the subject has reached a vertex.

18. The computer-readable non-transitory recording medium according to claim 6, the computer-executable program instructions when executed further causing the computer system to execute operations comprising:
storing a video of the subject corresponding to a needed determination time needed for determining that the subject has reached the vertex and delays the video, wherein
the identifying further comprises determining the vertex position of the subject input from the stored video of the subject.

19. The computer-readable non-transitory recording medium according to claim 6, wherein the subject includes a sport player playing a sport, and
the displaying further comprises displaying a trajectory of an arc according to the subject moves back and forth.

20. The computer-readable non-transitory recording medium according to claim 6, wherein the displaying the virtual image of the subject maintains a realistic sense of depth when the subject moves in a wide range in a depth direction of the imaged video.
